(19) United States
(12) Patent Application Publication
(10) Pub. No.: US 2012/0257179 A1
(43) Pub. Date: Oct. 11, 2012

(54) APPARATUS AND METHODS TO RECOVER LIQUID IN IMMERSION LITHOGRAPHY

(75) Inventors: Derek COON, Redwood City, CA (US); Leonard Wai Fung KHO, San Francisco, CA (US); Alex Ka Tim POON, San Ramon, CA (US)

(73) Assignee: NIKON CORPORATION, Tokyo (JP)

(21) Appl. No.: 13/314,860

(22) Filed: Dec. 8, 2011

Related U.S. Application Data
(60) Provisional application No. 61/472,417, filed on Apr. 6, 2011.

(51) Int. Cl. G03B 27/52

(52) U.S. Cl. 355/30

(57) ABSTRACT

Methods and apparatus remove liquid from a surface of a substrate, a substrate table, or both, by applying a vacuum to a passage having first and second opposite ends while the first end is in contact with or close to the liquid. This causes the liquid to flow into the first end of the passage as part of a gas/liquid mixture. At least part of the passage between the first and second ends contacts a porous member. The liquid of the gas/liquid mixture is absorbed into the porous member such that substantially only gas is present at the second end of the passage. Thus, substantially only gas flows towards a vacuum source of the vacuum. A second vacuum may be applied to a collection chamber that contacts the porous member to draw the liquid of the gas/liquid mixture from the passage through the porous member and into the collection chamber.

### CROSS-REFERENCE TO RELATED APPLICATIONS

This application claims the benefit of U.S. Provisional Application No. 61/472,417 filed Apr. 6, 2011, The disclosure of the provisional application is incorporated herein by reference in its entirety.

### BACKGROUND

The present disclosure relates to, for example, immersion lithography apparatus and methods, and particularly to apparatus and methods for recovering immersion fluid. More broadly, the disclosure relates to methods and apparatus for collecting liquids using a vacuum.

A typical lithography apparatus includes a radiation source, a projection optical system and a substrate stage to support and move a substrate to be imaged. A radiation-sensitive material, such as a resist, is coated onto the substrate surface before the substrate is placed on the substrate stage. During operation, radiation energy from the radiation source is used to project an image defined by an imaging element through the projection optical system onto the substrate. The projection optical system typically includes a plurality of lenses. The lens or optical element closest to the substrate can be referred to as the last or final optical element.

The projection area during exposure is typically much smaller than the surface of the substrate that is subjected to the exposure operation. The substrate therefore is moved relative to the projection optical system in order to pattern the entire surface of the substrate. In the semiconductor industry, two types of lithography apparatus are commonly used. With so-called “step-and-repeat” apparatus, the entire image pattern is projected at one moment in a single exposure onto a target area of the substrate. After the exposure, the substrate is moved or “stepped” in the X and/or Y direction(s) and a new target area is exposed. This step-and-repeat process is performed multiple times until the entire substrate surface is exposed. With scanning type lithography apparatus, the target area is exposed in a continuous or “scanning” motion. For example, when the image is projected by transmitting light through a reticle or mask, the reticle or mask is moved in one direction while the substrate is moved in either the same or the opposite direction during exposure of one target area. The substrate is then moved in the X and/or Y direction(s) to the next scanned target area. The process is repeated until all of the desired target areas on the substrate have been exposed.

Lithography apparatus are typically used to image or pattern semiconductor wafers and flat panel displays. The word “substrate” as used herein is intended to generically mean any workpiece that can be patterned including, but not limited to, semiconductor wafers and flat panel displays.

Immersion lithography is a technique that can enhance the resolution of lithography exposure apparatus by permitting exposure to take place with a numerical aperture (NA) that is greater than the NA that can be achieved in conventional “dry” lithography exposure apparatus having a similar optical system. By filling the space between the final optical element of the projection system and the resist-coated substrate with an immersion liquid, immersion lithography permits exposure with light that would otherwise be internally reflected at the optic-air interface. Numerical apertures as high as the index of the immersion liquid (or of the resist or lens material, whichever is least) are possible in immersion lithography systems. Liquid immersion also increases the substrate depth-of-focus, that is, the tolerable error in the vertical position of the substrate, by the index of the immersion liquid compared to a dry system having the same numerical aperture. Immersion lithography thus can provide resolution enhancement without actually decreasing the exposure light wavelength. Thus, unlike a shift in the exposure light wavelength, the use of immersion would not require the development of new light sources, optical materials (for the illumination and projection systems) or coatings, and can allow the use of the same or similar resists as conventional “dry” lithography at the same wavelength. In an immersion system in which only the final optical element of the projection system and its housing and the substrate (and perhaps portions of the stage as well) are in contact with the immersion liquid, much of the technology and design developed for dry lithography can carry over directly to immersion lithography.

However, because the substrate moves rapidly in a typical lithography system, the immersion liquid in the immersion area including the space between the projection system and the substrate tends to be carried away from the immersion area. Even when substrate movements do not cause liquid to escape, it is common for droplets or a thin film of residual liquid to remain on portions of the surface of the substrate and/or the stage after an exposure operation has been completed. If the immersion liquid escapes from the immersion area and/or remains after exposure, that liquid can interfere with operation of other components of the lithography system. Furthermore, evaporation of the liquid reduces the temperature of the surroundings, which can adversely affect system operations. One way to recover the immersion liquid and prevent the immersion liquid from contaminating the immersion lithography system is described in US2006/0152697 A1, the disclosure of which is incorporated herein by reference in its entirety. Also see US2007/0222967 A1, the disclosure of which is incorporated herein by reference in its entirety.

The systems described in US2006/0152697 A1 and US2007/0222967 A1 include an immersion liquid confinement member. The immersion liquid confinement member includes an outlet through which immersion liquid is recovered (collected) from the immersion area. The outlet is covered by a liquid-permeable member such as a mesh or porous member. A vacuum control unit applies suction to a chamber associated with the outlet so as to draw the immersion liquid on the substrate through the liquid-permeable member and the outlet.

Many immersion liquid recovery apparatus recover some (or all) of the immersion liquid by suctioning a gas/liquid mixture through one or more recovery channels. The gas/liquid mixture passes through one or more recovery channels that may or may not be covered by a porous member. These systems typically employ a gas curtain to assist in maintaining the liquid in the immersion area. With a gas curtain design, an immersion element, typically with gas inlets and outlets, surrounds the final optical element of the projection system. The gas inlets are used to create a curtain of gas surrounding the exposure area, maintaining the fluid localized within the gap under the final optical element. The gas outlets are provided to remove the gas and any immersion fluid that may escape from the gap. See, for example, U.S. Patent Publications US200S/0007569, US2006/0087630, US2006/0158627 and US2006/0038968, the disclosures of which are incorporated herein by reference in their entireties.

### SUMMARY

When liquid is collected by inducing a flow of a gas/liquid mixture through a liquid recovery channel or passage, the gas flow that is used to pick up the liquid tends to cause the picked-up liquid to evaporate as the liquid flows through the liquid recovery channel. This evaporative cooling is detrimental to operation of the device because it lowers the temperature of the surroundings, which can affect the accuracy of measurements that are made in the device and/or can cause components (including the substrate or stage surface from which the liquid was collected) to cool and thus contract.

In accordance with at least some aspects of the invention, the problem of evaporative cooling when liquid is picked up from a surface using gas flow is addressed by separating the liquid from gas as quickly as possible by causing the gas/liquid mixture to contact a porous, absorbent member which removes the liquid from the mixture while allowing the gas to continue flowing towards a vacuum source that is used to recover the liquid from the surface. This reduces evaporative cooling by quickly separating the liquid from the gas.

In addition, separating the liquid and the gas reduces vibrations that occur when a liquid/gas mixture is conveyed through a passage.

In accordance with some embodiments, a method of removing liquid from a surface of a substrate, a substrate table, or both, includes applying a vacuum to a passage having first and second opposite'ends at least while the first end is in contact with or close to the liquid. This causes the liquid to flow into the first end of the passage as part of a gas/liquid mixture. At least a portion of the passage between the first and second ends of the passage contacts an absorptive porous member, the porous member contacting at least first and second opposite sides of the passage. The liquid of the gas/liquid mixture is absorbed into the porous member such that substantially only gas is present at the second end of the flow passage. Thus, substantially only gas flows towards a vacuum source of the vacuum that is used to cause the liquid to flow into the passage.

According to some embodiments, the porous member encircles the passage such that the passage passes through the porous member. A width of the passage preferably is larger than a pore size of pores of the porous member. In some embodiments, the passage includes an inlet port located at the first end of the passage, and the porous member through which the liquid passes contacts the inlet port.

According to preferred embodiments, a second vacuum is applied to the porous member at a position away from the passage to draw the liquid of the gas/liquid mixture from the passage into the porous member. The second vacuum preferably is below a bubble point of the porous member such that only liquid is drawn into the porous member. Maintaining the second vacuum below the bubble point of the porous member prevents gas from being drawn into the porous member, and thus prevents evaporative cooling of the liquid that has been drawn into the porous member.

According to some embodiments, the liquid that has been absorbed by the porous member is collected in a collection chamber after passing through the porous member. The collection chamber is in fluid-communication with a source of the second vacuum. Preferably gas from the gas/liquid mixture is not introduced into the collection chamber.

According to some embodiments, the passage is disposed in an immersion nozzle of a liquid immersion lithography apparatus. The immersion nozzle surrounds a final optical element of a projection system of the liquid immersion lithography apparatus. The immersion nozzle also can include a liquid supply passage for supplying the liquid to a gap between the final optical element and the surface of the substrate, the substrate table, or both. The passage can be a primary liquid recovery passage that is used to recover most (if not all) of the immersion liquid from, an immersion area that is formed between the final optical element and the surface of the substrate, the substrate table, or both. Alternatively, or in addition, the passage can be a secondary liquid recovery passage that recovers residual liquid (i.e., liquid that was not recovered by a primary liquid recovery port) that escapes from the immersion area or that remains on the surface of the substrate, the substrate table, or both, after exposure of the substrate.

According to some embodiments, the passage is disposed in a droplet-removal nozzle of a liquid immersion lithography apparatus. The droplet-removal nozzle is disposed between a projection system of the liquid immersion lithography apparatus and a substrate-mounting/removal station of the liquid immersion lithography apparatus, and is used to remove any residual liquid that remains on the surface of the substrate, the substrate table, or both, after an exposure process has been completed for the substrate.

According to some embodiments, a liquid removal device is provided for removing liquid from a surface of a substrate, a substrate table, or both. The device includes a passage having first and second opposite ends configured such that when the second end is communicated with a vacuum source while the first end is in contact with a liquid, the liquid is caused to flow into the first end of the passage as part of a gas/liquid mixture. An absorptive porous member contacts at least a portion of the passage between the first and second ends. A collection chamber, which is in fluid-communication with the porous member at a position away from the passage, applies a vacuum to the porous member so that the liquid of the gas/liquid mixture in the passage is absorbed into the porous member such that substantially only gas is present at the second end of the passage to flow toward the vacuum source.

According to preferred embodiments, the vacuum applied to the porous member by the collection chamber is below a bubble point of the porous member.

According to some embodiments, the passage extends vertically upward from the first end of the passage.

According to some embodiments, the passage includes one or more bends spaced from the first end of the passage. The porous member preferably forms a surface of the bend(s). Such a design helps to absorb any remaining liquid in the passage into the porous member when that liquid strikes the surface of the bend(s).

According to some embodiments, the passage is open and contains no obstructions.

An immersion lithography apparatus can be provided that includes the liquid removal device. Such an immersion lithography apparatus includes a projection system, a movable stage and a confinement member that includes the liquid removal device. The projection system includes a final optical element. The movable stage detachably holds a substrate and is movable to a position below the projection system such that a gap exists between the final optical element and a surface of the substrate, the movable stage, or both. An immersion liquid is filled in the gap between the final optical element and the surface. The confinement member maintains the immersion liquid in the gap between the surface and the final optical element, whilst the liquid removal device removes liquid from the gap via the passage.

According to preferred embodiments, the confinement member surrounds the final optical element, and the passage extends through the confinement member around the final optical element so as to recover the immersion liquid from positions around an immersion area that is formed between the final optical element and a surface of the substrate held by the movable stage, the movable stage, or both.

Other aspects of the invention relate to methods of manufacturing devices using the immersion lithography apparatus.

### BRIEF DESCRIPTION OF THE DRAWINGS

The invention will be described in conjunction with the following drawings of exemplary embodiments in which like reference numerals designate like elements, and in which:

FIG. 1A shows a conventional liquid removal device in which a liquid recovery passage extends through a metal, non-absorptive member;

FIG. 1B shows the FIG. 1A device after a gas/liquid mixture enters a passage of the device;

FIG. 2A shows a liquid removal device according to an embodiment of the invention in which a liquid recovery passage contacts an absorptive porous member;

FIG. 2B shows the FIG. 2A device after a gas/liquid mixture enters a passage of the device;

FIG. 3 shows an alternative embodiment of the device of FIGS. 2A-2B;

FIG. 4A shows relative humidity in the liquid recovery passage over time when droplets are picked-up by the device of FIGS. 1A-1B, and FIG. 4B shows the temperature in the passage over time;

FIG. 5A shows relative humidity in the liquid recovery passage over time when droplets are picked-up by the device of FIG. 3 with the porous member being dry, and FIG. 5B shows temperature in the passage over time;

FIG. 6A shows relative humidity in the liquid recovery passage over time when droplets are picked-up by the device of FIG. 3 with the porous member being wet, and FIG. 6B shows temperature in the passage over time;

FIG. 7 is a simplified elevational view schematically illustrating an immersion lithography system according to some embodiments of the invention;

FIG. 8 is a simplified side cross-sectional view of a liquid confinement member and its fluid removal system according to an embodiment of the invention;

FIG. 9 is a simplified side cross-sectional view of a liquid confinement member and its fluid removal system according to another embodiment of the invention;

FIG. 10 shows a liquid removal device according to another embodiment of the invention;

FIG. 11 shows a liquid removal device according to another embodiment of the invention;

FIG. 12 is a simplified plan view of a droplet removal device according to another embodiment of the invention;

FIG. 13 is a flowchart that outlines a process for manufacturing a device in accordance with an aspect of the invention; and

FIG. 14 is a flowchart that outlines device processing in more detail.

### DETAILED DESCRIPTION OF EMBODIMENTS

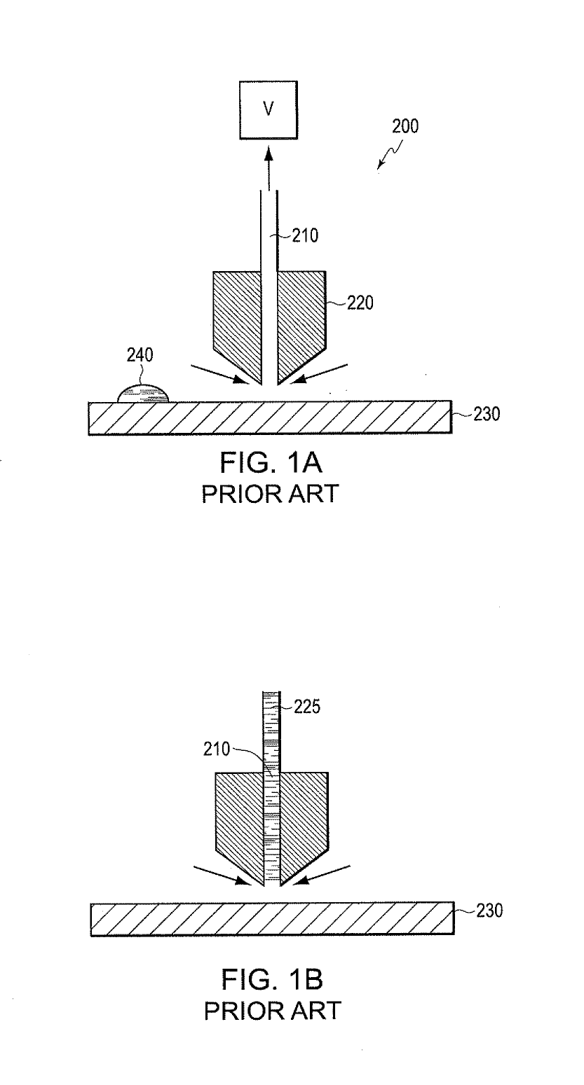

FIGS. 1A and 1B illustrate how evaporative cooling occurs when liquid is removed through a non-porous passage. FIG. 1A shows a liquid removal device 200 in which a passage 210 through a solid (for example, metal) member 220 is used to recover liquid from a surface. In particular, a droplet 240 is recovered from surface 230 by applying a vacuum supplied by a vacuum source V through an upper end of the passage 210. As shown by the arrows in FIG. 1A, before the droplet 240 reaches the liquid removal device 200, gas flows into the lower end of the passage and flows up the passage 210 toward the vacuum source V. After the lower end of the passage 210 has taken-up the droplet 240, as shown in FIG. 1B, a gas/liquid mixture 225 exists within the passage 210. This gas/liquid mixture flows through the passage 210 to a collection chamber (not shown) that is in communication with the vacuum source V. The collection chamber typically is spaced a long distance from the inlet of the liquid removal device 200, and thus the gas/liquid mixture travels a long distance to the collection chamber. Accordingly, a significant amount of the liquid evaporates into the gas of the gas/liquid mixture causing evaporative cooling.

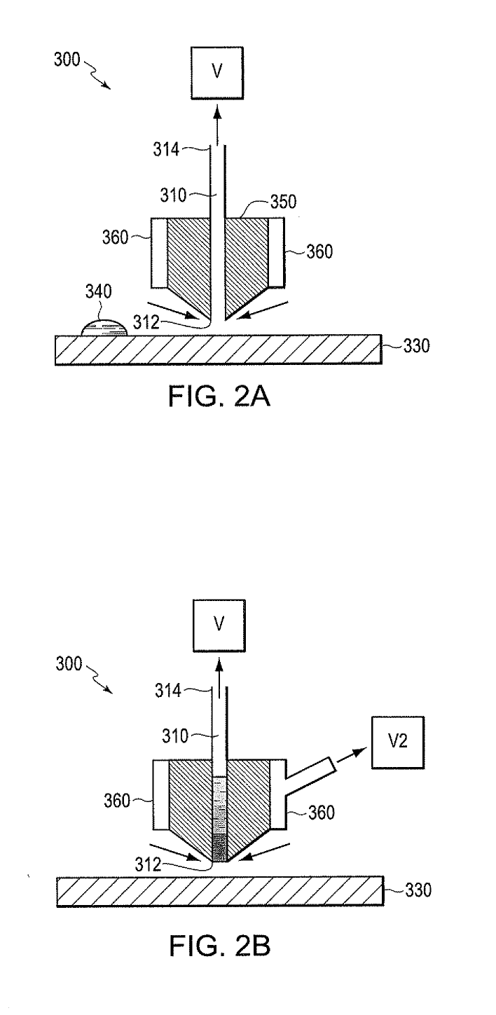

FIGS. 2A and 2B illustrate a liquid removal device incorporating at least some aspects of the invention. The liquid removal device 300 includes a passage 310 having a first, or lower end 312 into which liquid initially flows, and a second, or upper end 314 that communicates with a vacuum source V. Unlike the passage 210 in FIGS. 1A and 1B, the passage 310 in FIGS. 2A and 2B passes through or by (the passage contacts) an absorptive, porous member 350. At least some, and preferably all, of the passage starting from the first end 312 and extending at least part of the way toward the second end 314 contacts the absorptive, porous member 350. As shown by the arrows in FIG. 2A, before the droplet 340 reaches the first end 312 of the passage 310, gas flows into the end 312 and up through the passage 310 toward the vacuum source V.

As shown in FIG. 2B, after the liquid has been recovered into the passage 310, a gas/liquid mixture exists within the passage 310. As the gas/liquid mixture flows through the passage 310 toward the second end 314 and the vacuum source V, the liquid is absorbed into the absorptive, porous member 350. FIG. 2B illustrates this absorption by showing the gas/liquid mixture in progressively lighter shading. That is, as more liquid is absorbed into the absorptive, porous member 350, the mixture has a higher percentage of gas and is shown with lighter shading. Eventually, all of the liquid is absorbed into the porous member 350 such that only gas flows toward the vacuum source V.

A collection chamber 360 is provided in contact with the absorptive, porous member 350 at a location away from the passage 310. A second vacuum source V2 is communicated with the collection chamber 360 to draw the liquid into the porous member 350 from the gas/liquid mixture in the passage 310. In order to prevent gas from being drawn into the porous member 350, the vacuum source V2 is controlled to apply a vacuum that is below the bubble-point of the porous member 350. Accordingly, the liquid removal device 300 separates the liquid from the gas of the gas/liquid mixture quickly after the liquid is recovered from the surface 330, thereby reducing the opportunity for the liquid in the gas/liquid mixture to evaporate, and thereby reducing the opportunity for evaporative cooling to occur.

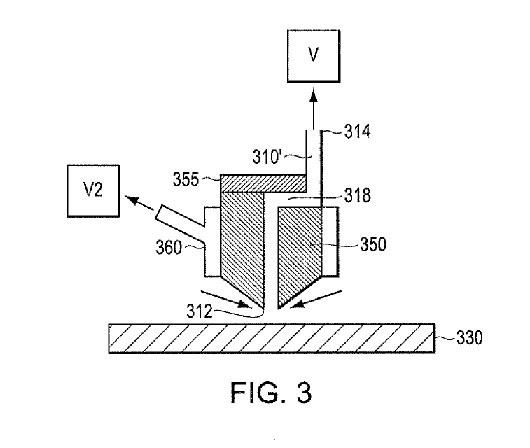

FIG. 3 shows an alternative, preferred embodiment that is similar to the embodiment of FIGS. 2A-2B, except that the passage 310′ includes a bend 318 that contacts an additional piece 355 of the porous member 350/355. The bend 318 improves the absorption of liquid into the porous member 350/355 by causing any remaining liquid in the passage 310′ to directly contact the porous member 355, which further facilitates absorption of the liquid. More than one bend could be included.

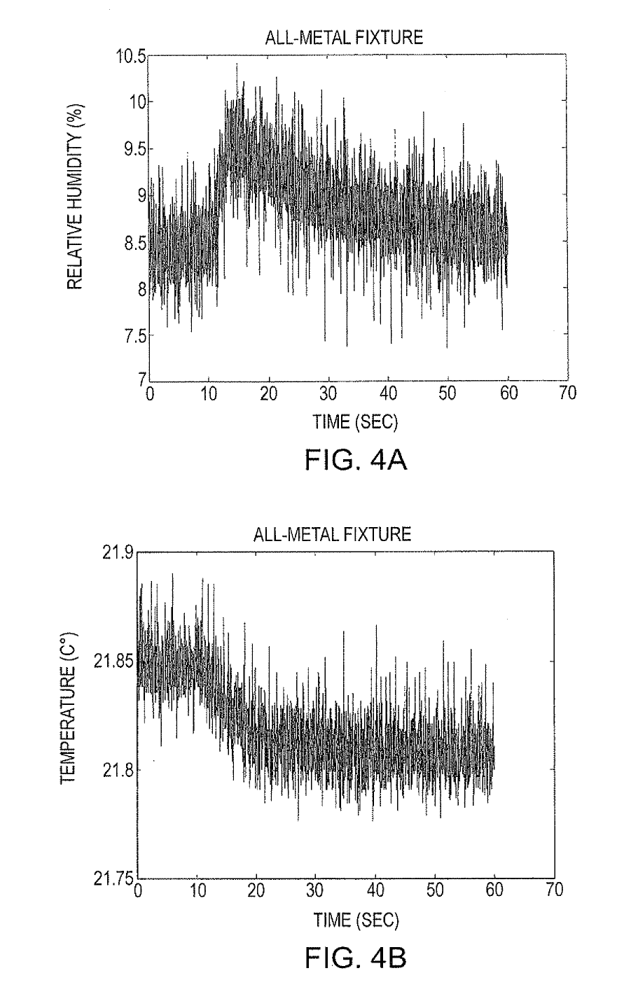

FIGS. 4A-6B illustrate the results of tests that were conducted in order to compare a liquid removal device having a passage in contact with an absorptive material versus one having a passage in contact with a non-absorptive material such as metal.

A liquid removal device having an architecture similar to what is shown in FIGS. 1A and 1B was used to collect liquid droplets from a surface. The vacuum passage passed through a metal member, and thus liquid in the gas/liquid mixture entering the passage was not absorbed into the member. The experimental conditions were as follows: 25 droplets each having a volume of 1 μL were placed on a glass wafer substrate. The gap between the wafer and the inlet of the passage was set at 200 μm. The passage was slit-shaped in cross section with the slit having a width of 50 μm. The air flow through the liquid removal device was 18 LPM (liters per minute). The scanning speed of the substrate was 500 mm/sec. After the above flow conditions had stabilized, ten seconds of data was collected and then the wafer was scanned below the liquid removal device so as to collect the 25 droplets. The humidity and temperature of the gas flowing through passage of the liquid removal device were measured and are shown in FIGS. 4A and 4B. As shown in FIG. 4A, the humidity in the vacuum line downstream of the liquid removal device increased about 1% after the droplets passed through the device, and then returned to the original value after about 60 seconds. As shown in FIG. 4B, after the droplets were collected, the temperature fell about 50 mK. This temperature drop is the result of evaporative cooling.

A similar procedure then was performed using a liquid removal device having an architecture similar to what is shown in FIG. 3. The width of the slit was 200 μm. The slit was formed between two rectangular pieces of porous material having a bubble point of −15 kPa. The porous material was SF6, which is a silicon carbide porous ceramic with an average hole pore size of 6 μm, supplied by Refractron Technologies, Newark, N.Y. (http://www.refractron.com/). Other materials can be used, such as aluminum oxide porous ceramic, for example. The other test conditions were the same as in the first test (25 droplets of size 1 μL, gap width of 200 μm, airflow of 18 LPM and wafer scanning speed of 500 mm/sec.).

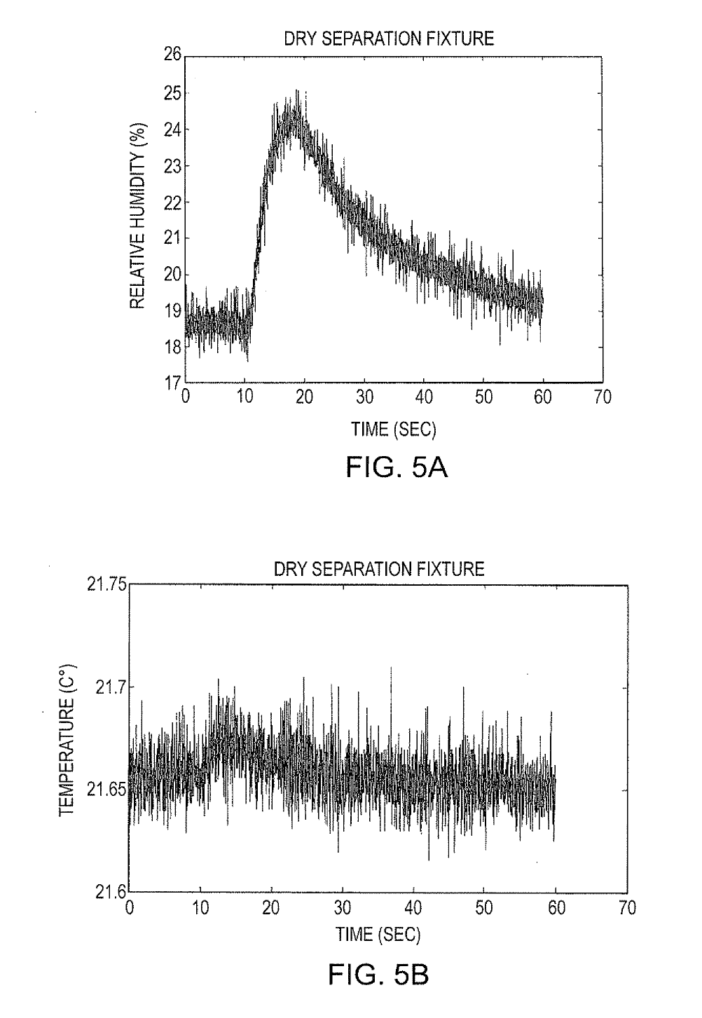

First, the test was performed in a state in which the porous material was dry (i.e., the porous material was not pre-wetted). As can be seen from FIG. 5A, the humidity increased by about 6%. This can be explained by the fact that the absorptive liquid removal device, even when dry, is much better at picking up water droplets than the all-metal device. The porous material used was not very naturally hydrophilic, and thus it did not absorb the liquid very well when it was dry, although it improved the ability to remove the liquid from the wafer. As shown in FIG. 5B, a slight temperature change is shown at 10 seconds, but it is not as much of a change as in the all metal fixture. Furthermore, the change is a temperature increase. Thus, the change is likely due to a temperature change in the external environment (which was not precisely controlled).

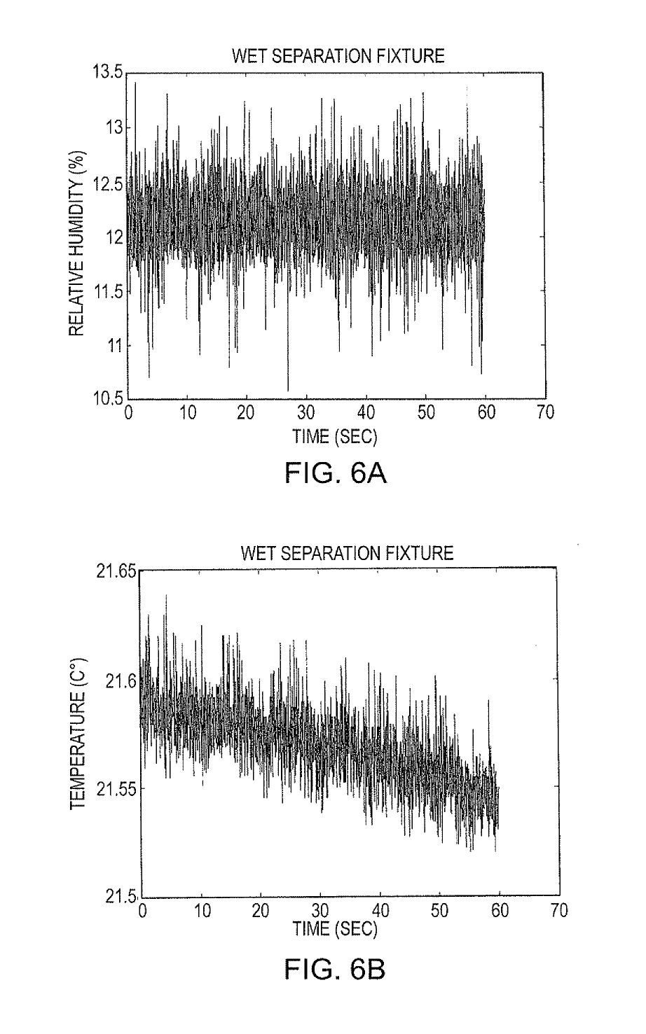

Finally, a similar test was conducted with the same device based on the FIG. 3 architecture, except that the porous material was saturated with liquid prior to conducting the test. As can be seen from FIG. 6A, there was no increase in humidity even after the droplets were picked-up. Moreover, the droplet pick-up efficiency was best in this configuration (that is, the smallest amount of water remained on the wafer for the test in which the absorbent porous liquid removal device was pre-wetted). FIG. 6B shows the temperature plot. It appears that the environmental conditions were drifting at the time of the scan because the temperature continuously decreases. However, because there is no change in slope after 10 seconds, it appears that very little temperature change was caused by picking up the droplets with the wet porous liquid removal device.

In addition, separating the liquid and the gas reduces vibrations that occur compared to existing arrangements in which a liquid/gas mixture is conveyed through the entire length of the passage.

Improved liquid containment devices in which an immersion area is contained between the final optical element of a projection system of an immersion lithography device and a surface of a substrate, substrate table, or both, will now be described.

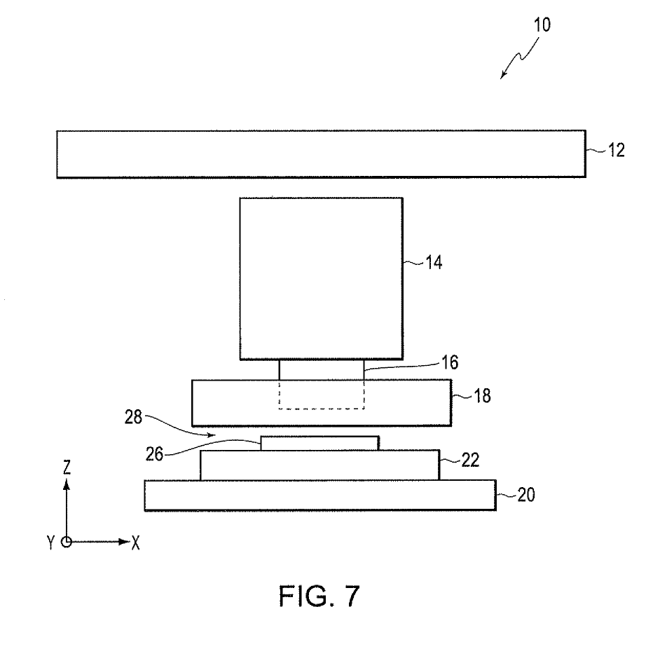

FIG. 7 shows an immersion lithography system 10 including a reticle stage 12 on which a reticle is supported, a projection system 14 having a last or “final” optical element 16, and a fine-movement stage 22 on which a substrate 26 is supported, which in turn is movable over a coarse-movement stage 20. An immersion liquid supply and recovery apparatus 18, which is sometimes referred to herein as a liquid confinement member 18 or an immersion nozzle, is disposed around the final optical element 16 of the projection system 14 so as to supply and recover an immersion fluid, which may be a liquid such as, for example, water, to/from a gap 28 between the final optical element 16 and the substrate 26. In the present embodiment, the immersion lithography system 10 is a scanning lithography system in which the reticle and the substrate 26 are moved synchronously in respective scanning directions during a scanning exposure operation. The fine-movement stage 22 controls the position of the substrate 26 in one or more (preferably all) of the X, Y, Z, θX, θY and θZ directions with a higher degree of precision than the coarse-movement stage 20, which is primarily used for moving the substrate 26 over longer distances, as is well known in the art. The upper surface of the fine movement stage 22 includes a substrate holder that preferably has a recess that holds the substrate 26. In addition, a portion of the upper surface of the fine movement stage 22 that surrounds the held substrate has an upper surface that is substantially level with the upper surface of the held substrate so that when the immersion area is located near the edge of the substrate, liquid is still maintained between the liquid confinement member 18 and the upper surfaces of the substrate 26 and of the substrate holder.

The illumination source of the lithography system can be a light source such as, for example, a mercury g-line source (436 nm) or i-line source (365 nm), a KrF excimer laser (248 nm), an ArF excimer laser (193 nm) or a F₂ laser (157 nm). The projection system 14 projects and/or focuses the light passing through the reticle onto the substrate 26. Depending upon the design of the exposure apparatus, the projection system 14 can magnify or reduce the image illuminated on the reticle. It also could be a 1× magnification system.

When far ultraviolet radiation such as from the excimer laser is used, glass materials such as silica glass and calcium fluoride that transmit far ultraviolet rays can be used in the projection system 14. The projection system 14 can be catadioptric, completely refractive or completely reflective.

With an exposure device, use of the catadioptric type optical system can be considered. Examples of the catadioptric type of optical system are shown in U.S. Pat. No. 5,668,672 and U.S. Pat. No. 5,835,275. In these cases, the reflecting optical device can be a catadioptric optical system incorporating a beam splitter and concave mirror. U.S. Pat. No. 5,689,377 also uses a reflective-refracting type of optical system incorporating a concave mirror, etc., but without a beam splitter, and also can be employed with this invention. The disclosures of the above-mentioned U.S. patents are incorporated herein by reference in their entireties.

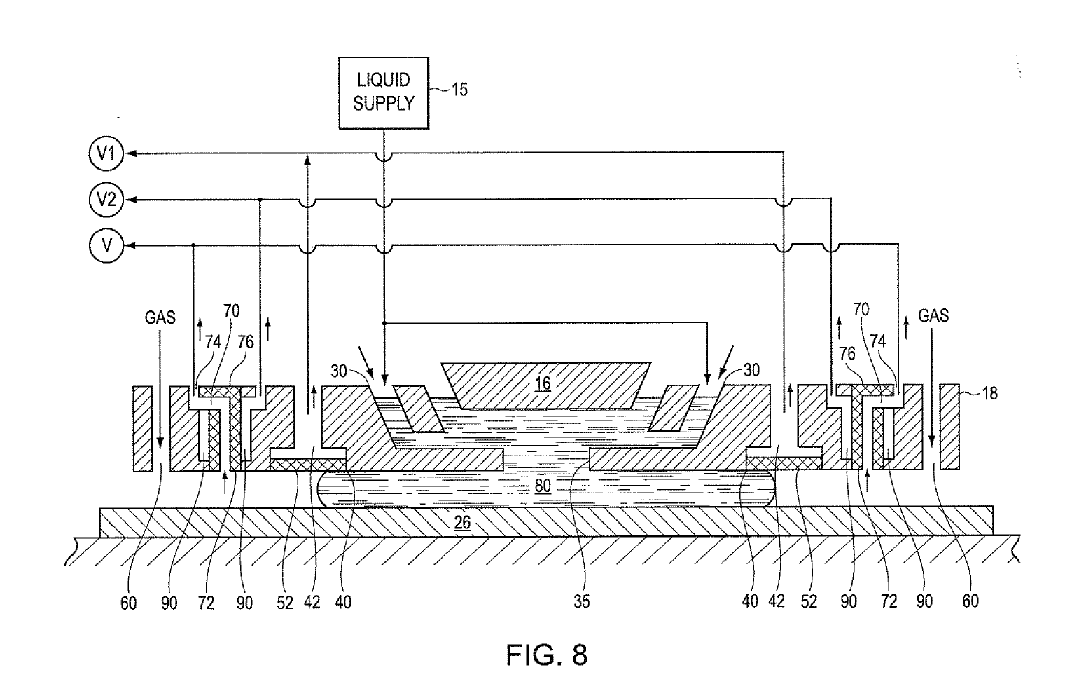

FIG. 8 is a cross-section view of an embodiment of a liquid confinement member 18. As shown in FIG. 8, the liquid confinement member 18 maintains immersion liquid 80 in an immersion area, which includes the gap or space between the final optical element 16 of the projection system 14 and a portion of the upper surface of the substrate 26. The immersion liquid 80 in FIG. 8 can be seen as occupying only a portion of the upper surface of the substrate 26. That is, the size of the immersion area is smaller than the size of the upper surface of the substrate 26 such that only part of the upper surface of the substrate is covered. Depending on the relative position of the substrate 26 with respect to the projection system 14 (and the liquid confinement member 18) the immersion area can be disposed over the substrate, over a portion of the substrate and a portion of the substrate holder that surrounds the substrate, or over only a portion of the substrate holder (for example, when the substrate is moved such that it no longer is disposed below the projection system 14). In addition, if the exposure apparatus includes a measurement stage that is used to take measurements regarding the projection system 14, the immersion area can be formed between an upper surface of the measurement stage and the final optical element 16 (there would be no substrate holder on the measurement stage).

The liquid confinement member 18 includes at least one (and preferably more than one) liquid supply inlets 30 through which the immersion liquid 80 is supplied to the immersion area. The liquid is supplied to the supply inlets 30 through a supply path, one end of which is connected to a liquid supply 15 and the other end of which is connected to an inlet manifold of the liquid confinement member 18. The liquid supplied to the supply inlets 30 reaches the substrate 26 after passing through aperture 35 disposed centrally in the confinement member 18. As shown in FIG. 8, the supply and recovery of the immersion liquid is controlled so that the level of the immersion liquid between the liquid confinement member 18 and the final optical element 16 is maintained above the lower surface of the final optical element 16 so that the exposure light transmitted through the projection system 14 travels only through the immersion liquid (that is, the exposure light does not travel through any air or gas) before reaching the substrate 26.

In the FIG. 8 embodiment, the liquid confinement member 18 includes an outlet 40. In the FIG. 8 embodiment, the outlet 40 is an annular groove that surrounds aperture 35, and thus also surrounds the immersion area. Liquid is removed from the immersion area and from the surface of the substrate 26 (and/or the surface of the substrate holder) via the outlet 40. The outlet 40 is covered by a liquid-permeable member 52 such that a first chamber 42 is disposed at least partially within the liquid confinement member 18. A first (lower) surface of the liquid-permeable member 52 faces toward the substrate 26, whereas a second (upper) surface of the liquid-permeable member 52 contacts the chamber 42. Liquid that passes through the first liquid-permeable member 52 from its first surface to its second surface thus enters the first chamber 42.

Although the outlet 40 (and thus also the liquid-permeable member 52) is a continuous groove in FIG. 8, the outlet 40 (and thus the liquid-permeable member 52 covering the outlet) could be a series of arc-shaped portions, straight portions or angled portions that collectively surround the immersion area and communicate with first chamber 42. Furthermore, the outlet 40 could be circular in plan view, rectangular or any other shape in plan view.

The first chamber 42 communicates with a first vacuum system V1 that applies a suction force to the first chamber 42. The suction force is sufficient to draw immersion liquid through the liquid-permeable member 52 into the first chamber 42. The first vacuum system V1 is controlled so that the suction force applied to the liquid-petineable member 52 is maintained below the bubble point of the liquid-permeable member 52. That is, the first vacuum system V1 controls a pressure in the first chamber 42 such that substantially only liquid is removed from the immersion area and/or from the surface of the substrate 26 (and/or the surface of the substrate holder) through the liquid-permeable member 52, but not gas from the surface of the substrate 26 (and/or the surface of the substrate holder).

Although the first vacuum system V1 removes most of the liquid, due to fast movements of the substrate, some droplets break free from the immersion area and are not recovered through the liquid-permeable member 52. In addition, a film of liquid may remain on portions of the wafer surface and/or the wafer holding surface after the immersion area has moved away from that portion of the surface.

In order to recover such residual liquid droplets or film, and to prevent such liquid from scattering throughout the lithography apparatus, it is known to supply gas at a high velocity via a gas inlet (for example, so as to form a gas curtain or gas knife) via the liquid confinement member 18 at a position radially outward of the liquid recovery outlet 40 and to also collect such liquid along with at least some of the gas with a vacuum collection outlet disposed radially inward of the gas inlet. See, for example, U.S. Patent Publication Nos. US2009/0002648 and US2006/0038968, the disclosures of which are incorporated herein by reference in their entireties.

The liquid confinement member 18 of FIG. 8 employs such a gas curtain by providing gas inlet passages 60 and gas removal passages 70. However, it also is possible to omit the gas inlet passages 60. The gas removal passages 70 are structured in accordance with aspects of the invention such that the gas removal passage 70 is structured similar to the liquid removal device shown in FIG. 3. In particular, each of the removal passages 70 includes a first (or lower) end 72 through which gas and liquid is collected, and a second (or upper) opposite end 74 that communicates with a vacuum source V. In addition, the passage 70 contacts an absorptive, porous member 76 that communicates with a collection chamber 90 which, in turn, communicates with a vacuum source V2. The vacuum source V2 applies a vacuum to the collection chamber 90 that is below the bubble point of the porous member 76. Accordingly, when a gas/liquid mixture enters the first end 72 of passage 70, the liquid will be absorbed into the porous member 76 and then collected in collection chamber 90. All of the liquid of the gas/liquid mixture is absorbed into the porous member 76 such that only gas is present at the second end 74 of the passage 70. Thus, substantially no liquid will reach the vacuum source V. Moreover, evaporative cooling is minimized in passage 70 because the liquid therein is quickly separated from the gas. In addition, no gas is drawn into the porous member 76 or into the collection chamber 90 from the passage 70.

In the FIG. 8 embodiment, the passage 70 includes a bend, and the absorptive member 76 surrounds the bend. Other configurations are possible. For example, the passage 70 could simply extend straight upward without having any bend. The passage 70 could be a continuous annular slit that extends completely around the immersion area or it could be a discontinuous series of arc-shaped slits or circular holes. Furthermore, the lowermost part of the passage could be a continuous groove having an upper part that communicates with one or more holes.

The porous member 76 could be two separate annular rings of porous material that are respectively located radially inward of and radially outward of the annular passage 70. Alternatively, the passage 70 could be formed by forming (for example, by drilling, etching and machining) one or more passages through a block of porous material. According to one embodiment, the porous member 76 is a porous silicon carbide material. The porous member 76 can be a porous ceramic material such as made by Refractron Technologies, Newark, N.Y. Many materials can be used for the porous member 76 such as, for example, aluminum oxide, silicon carbide, metal mesh, porous polytetrafluoroethylene, porous titanium and porous carbon. The typical pore size is 1 μm to 90 μm.

The vacuum systems V1 and V2 can be systems for controlling a vacuum force as described, for example, in US2006/0152697 A1 and US2007/0222967 A1, the disclosures of which are incorporated herein by reference in their entireties.

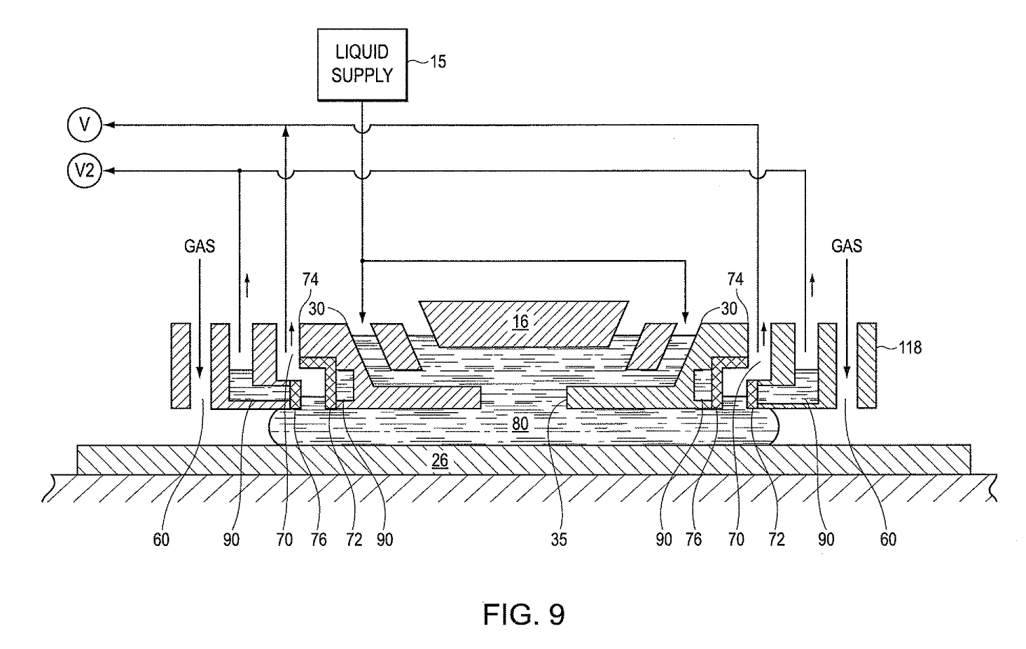

In the embodiment shown in FIG. 8, outlet 40 is used as the primary liquid removal outlet. That is, most of the liquid is removed through chamber 42 (after passing through outlet 40 and liquid-permeable member 52), and any remaining droplets are collected through the liquid removal passage 70. FIG. 9 illustrates an embodiment in which a liquid removal device having a structure similar to that shown in FIG. 3 is used as the primary liquid removal device for removing immersion liquid in the liquid confinement member.

The liquid confinement member 118 of FIG. 9 has a structure similar to the structure of FIG. 8 except that the chamber 42 and its associated structure (and vacuum source V1) are omitted. Thus, reference numerals similar to those used in FIG. 8 are used to identify similar structure in FIG. 9, and their detailed explanation will not be repeated. With this structure, the lower (inlet) end 72 of passage 70 contacts the immersion area fowled between the final optical element 16 and the upper surface of the substrate 26, substrate table, or both, so as to more continuously remove liquid. In this embodiment, the gas supplied through gas inlet passages 60 helps to prevent the liquid in the immersion area from breaking free of the liquid confinement member 118. However, similar to the FIG. 8 embodiment, the gas inlet passages 60 can be omitted. As with the FIG. 8 embodiment, liquid contained in the gas/liquid mixture that enters passage 70 through end 72 is quickly absorbed into the absorptive, porous member 76, flows into collection chamber 90 and is removed from collection chamber 90 due to the vacuum applied by vacuum source V2. Only liquid flows through the porous member 76, and thus there is no gas/liquid mixture in chamber 90. On the other hand, once the liquid has been absorbed into the porous member 76, only gas remains in passage 70. That gas exits end 74 and then travels to vacuum source V.

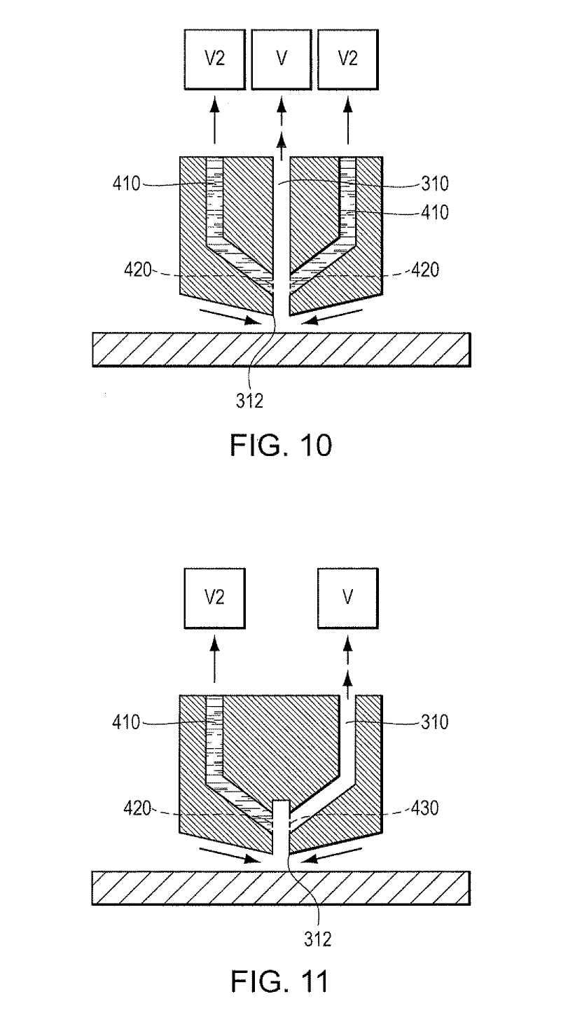

FIG. 10 shows another embodiment of the liquid removal device of FIGS. 2A and 2B. In the FIG. 10 embodiment, a hydrophilic mesh 420 is provided at the inlet end of each liquid-conveying passage 410 and functions as a porous member. Each liquid-conveying passage 410 communicates with a vacuum source V2 that is maintained below the bubble point of the hydrophilic mesh 420 so that only liquid is drawn through the mesh 420 and into the passage 410. A mesh as used herein is a thin piece of material such as metal that has many holes therethrough. The hole pitch is small, with the percentage opening being about 30%. That is, about 30% of the total area of the thin piece is occupied by the holes. Typically, the hole diameter is smaller than the pitch. In one embodiment, the hole diameter is less than about 40 μm and the pitch is less than about 90 μm. A hydrophilic mesh would have a contact angle of less than about 40°, and could be a UV clean metal or a mesh coated with a hydrophilic coating such as, for example, DLC.

FIG. 11 shows another embodiment of the liquid removal device of FIGS. 2A and 2B. In the FIG. 11 embodiment, a hydrophilic material 420 such as, for example, a mesh, as described above is provided at the inlet end of the liquid-conveying passage 410. The liquid-conveying passage 410 communicates with a vacuum source V2 that is maintained below the bubble point of the hydrophilic material 420 so that only liquid is drawn through the mesh 420 and into the passage 410. A hydrophobic material 430 such as, for example, a mesh, is provided adjacent the entrance to passage 310 through which only gas travels. Passage 310 communicates with a vacuum source V that is maintained below the bubble point of the hydrophobic material 430 such that only gas passes through the material 430. A hydrophobic material would have a contact angle of greater than about 90°, and could be a mesh as described above coated with a hydrophobic coating such as, for example, polytetrafluoroethylene.

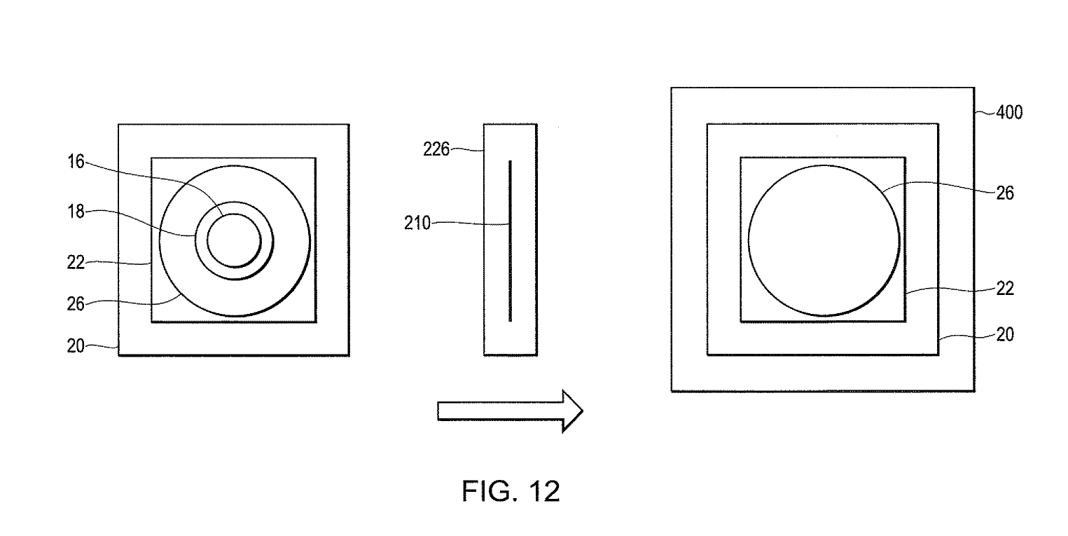

FIG. 12 shows an embodiment of a droplet removal device 226 that can be provided at a location between the projection system 26 of the liquid immersion lithography apparatus and another station 400, such as a measuring station or a wafer mounting/removal station. As shown in FIG. 12, the droplet removal device 226 has a length that preferably is longer than the width dimension of the substrate stage upper surface 22 that could potentially have droplets on it. Accordingly, when the stage moves below the droplet removal device 226, the droplet removal device will remove the droplets from the upper surface of the substrate 26 and/or the substrate-holding table 22 of the substrate stage. The liquid removal device 226 can have a structure similar to what is shown in FIGS. 2A-2B or FIG. 3, with the liquid removal passage 210 being an elongated slit formed between two porous plates, for example. The slit would extend for the entire length where liquid droplets are to be removed from the substrate and/or substrate table upper surface. For examples of the positioning (location) of a droplet removal device in an immersion lithography system, see, for example, U.S. Patent Publication No. US2008/0225248, the disclosure of which is incorporated herein by reference in its entirety.

In certain embodiments, the immersion fluid is a liquid having a high index of refraction. In different embodiments, the liquid may be pure water, or a liquid including, but not limited to, cedar oil, fluorin-based oils, “Decalin” or “Perhydropyrene.”

The liquid-permeable member 52 may be a porous member such as a mesh or may be formed of a porous material having holes typically with a size smaller than 150 μm. For example, the porous member may be a wire mesh including woven pieces or layers of material made of metal, plastic or the like, a porous metal, a porous glass, a porous plastic, a porous ceramic, a sponge or a sheet of material having chemically etched holes (for example, by photo-etching).

The use of the exposure apparatus described herein is not limited to a photolithography system for semiconductor manufacturing. The exposure apparatus, for example, can be used as an LCD photolithography system that exposes a liquid crystal display device pattern onto a rectangular glass plate, or a photolithography system for manufacturing a thin film magnetic head.

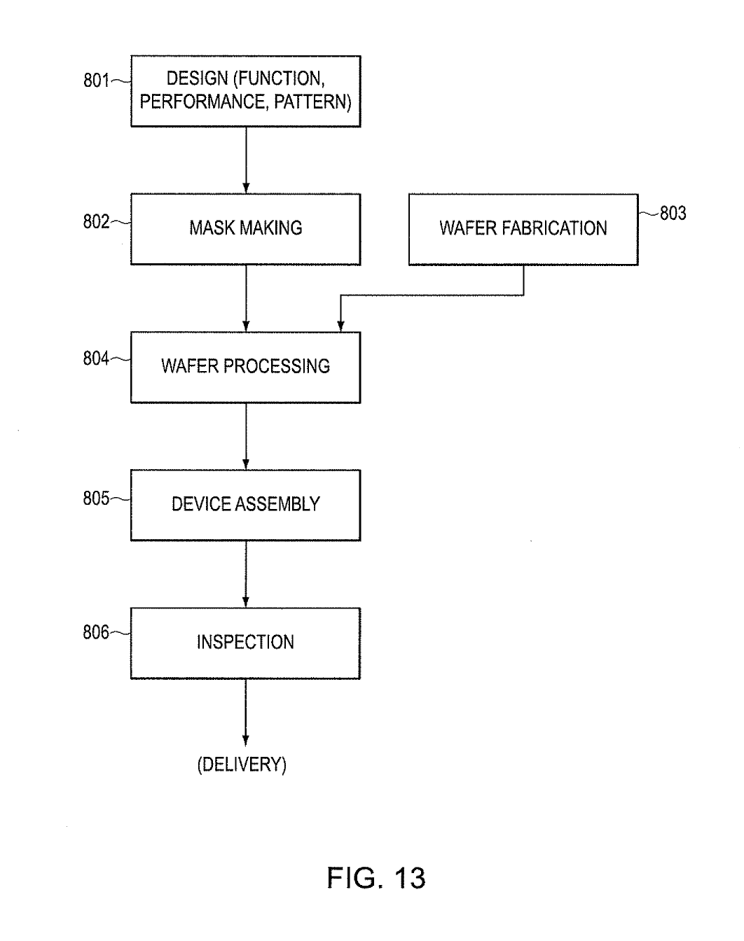

Semiconductor devices can be fabricated using the above described systems, by the process shown generally in FIG. 13. In step 801 the device's function and performance characteristics are designed. Next, in step 802, a mask (reticle) having a pattern is designed according to the previous designing step, and in a step 803, a wafer is made from a silicon material. The mask pattern designed in step 802 is exposed onto the wafer from step 803 in step 804 by a photolithography system described hereinabove in accordance with aspects of the invention. In step 805, the semiconductor device is assembled (including the dicing process, bonding process and packaging process). Finally, the device is then inspected in step 806.

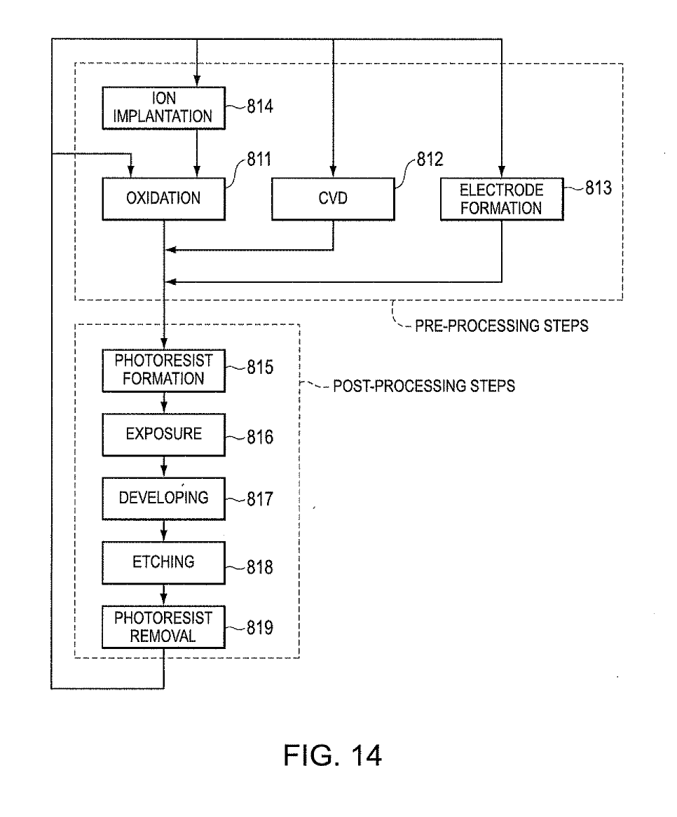

FIG. 14 illustrates a detailed flowchart example of the above-mentioned step 804 in the case of fabricating semiconductor devices. In FIG. 14, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 815 (photoresist formation step), photoresist is applied to a wafer. Next, in step 816 (exposure step), the above-mentioned exposure device is used to transfer the circuit pattern of a mask (reticle) to a wafer. Then in step 817 (developing step), the exposed wafer is developed, and in step 818 (etching step), parts other than residual photoresist (exposed material surface) are removed by etching. In step 819 (photoresist removal step), unnecessary photoresist remaining after etching is removed. Multiple circuit patterns are formed by repetition of these preprocessing and post-processing steps.

A photolithography system (an exposure apparatus) according to the embodiments described herein can be built by assembling various subsystems in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes providing mechanical interfaces, electrical circuit wiring connections and air pressure plumbing connections between each subsystem. Each subsystem also is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

While the invention has been described with reference to preferred embodiments thereof, it is to be understood that the invention is not limited to the preferred embodiments or constructions. The invention is intended to cover various modifications and equivalent arrangements. In addition, while the various elements of the preferred embodiments are shown in various combinations and configurations, that are exemplary, other combinations and configurations, including more, less or only a single element, are also within the spirit and scope of the invention.

What is claimed is:

1. A method of removing liquid from a surface of a substrate, a substrate table, or both, the method comprising:
applying a vacuum to a passage having first and second opposite ends at least while the first end is in contact with or close to the liquid so that the liquid is caused to flow into the first end of the passage as part of a gas/liquid mixture, at least a portion of the passage between the first and second ends contacting a porous member, the porous member contacting at least first and second opposite sides of the passage; and
absorbing the liquid of the gas/liquid mixture into the porous member such that substantially only gas is present at the second end of the passage to flow towards a vacuum source of the vacuum.

2. The method of claim 1, wherein the porous member encircles the passage such that the passage passes through the porous member.

3. The method of claim 2, wherein a width of the passage is larger than a pore size of pores of the porous member.

4. The method of claim 1, wherein the porous member through which the liquid passes contacts an inlet port of the passage located at the first end of the passage.

5. The method of claim 1, further comprising applying a second vacuum to the porous member at a position away from the passage to draw the liquid of the gas/liquid mixture from the passage into the porous member.

6. The method of claim 5, wherein the second vacuum is below a bubble point of the porous member.

7. The method of claim 5, wherein the liquid absorbed by the porous member is collected in a collection chamber after passing through the porous member, the collection chamber being in fluid-communication with a source of the second vacuum.

8. The method of claim 7, wherein the gas in the gas/liquid mixture is not drawn from the passage into the collection chamber.

9. The method of claim 1, wherein the liquid absorbed by the porous member is collected in a collection chamber after passing through the porous member.

10. The method of claim 1, wherein the passage is disposed in an immersion nozzle of a liquid immersion lithography apparatus, the immersion nozzle surrounding a final optical element of a projection system of the liquid immersion lithography apparatus, the immersion nozzle also including a liquid supply passage for supplying the liquid to a gap between the final optical element and the surface of the substrate, the substrate table, or both.

11. The method of claim 10, wherein the passage encircles an immersion area formed by the liquid in the gap.

12. The method of claim 1, wherein the passage is disposed in a droplet-removal nozzle of a liquid immersion lithography apparatus, the droplet-removal nozzle disposed between a projection system of the liquid immersion lithography apparatus and a substrate-mounting/removal station of the liquid immersion lithography apparatus.

13. The method of claim 1, wherein the passage extends vertically upward from the first end.

14. The method of claim 13, wherein the passage includes a bend spaced from the first end, the porous member forming a surface of the bend.

15. The method of claim 1, wherein the passage includes a bend spaced from the first end, the porous member forming a surface of the bend.

16. The method of claim 1, wherein the passage is open and contains no obstructions.

17. A liquid removal device for removing liquid from a surface of a substrate, a substrate table, or both, the device comprising:
a passage having first and second opposite ends configured such that when the second end is communicated with a vacuum source while the first end is in contact with or close to a liquid, the liquid is caused to flow into the first end of the passage as part of a gas/liquid mixture;
a porous member that contacts at least a portion of the passage between the first and second ends, the porous member contacting at least first and second opposite sides of the passage; and
a collection chamber in fluid-communication with the porous member at a position away from the passage, the collection chamber applying a vacuum to the porous member so that the liquid of the gas/liquid mixture in the passage is absorbed into the porous member such that substantially only gas is present at the second end of the passage to flow towards the vacuum source.

18. The device of claim 17, wherein the porous member encircles the passage such that the passage passes through the porous member.

19. The device of claim 18, wherein a width of the passage is larger than a pore size of pores of the porous member.

20. The device of claim 17, wherein the passage includes an inlet port located at the first end of the passage, the porous member through which the liquid passes contacting the inlet port.

21. The device of claim 17, wherein the vacuum applied to the porous member by the collection chamber is below a bubble point of the porous member.

22. The device of claim 17, wherein the passage extends vertically upward from the first end.

23. The device of claim 22, wherein the passage includes a bend spaced from the first end, the porous member forming a surface of the bend.

24. The device of claim 17, wherein the passage includes a bend spaced from the first end, the porous member forming a surface of the bend.

25. The device of claim 17, wherein the gas in the gas/liquid mixture is not drawn from the passage into the collection chamber.

26. The device of claim 17, wherein the passage is open and contains no obstructions.

27. An immersion lithography apparatus comprising:
a projection system having a final optical element;
a movable stage that detachably holds a substrate and is movable to a position below the projection system such that a gap exists between the final optical element and a surface of the substrate, the stage, or both, an immersion liquid being filled in the gap between the surface and the final optical element; and
a confinement member that maintains the immersion liquid in the gap between the surface and the final optical element, the confinement member including:
the liquid removal device of claim 17.

28. The immersion lithography apparatus of claim 27, wherein the confinement member surrounds the final optical element, and the passage extends through the confinement member to encircle an immersion area formed by the immersion liquid in the gap so as to recover the immersion liquid from positions around the immersion area.

29. The immersion lithography apparatus of claim 28, wherein the confinement member includes a liquid supply port that supplies the immersion liquid to the gap.

30. An immersion lithography apparatus comprising:
a projection system having a final optical element;
a movable stage that detachably holds a substrate and is movable to a position below the projection system such that a gap exists between the final optical element and a surface of the substrate, the stage, or both, an immersion liquid being filled in the gap between the surface and the final optical element;
a substrate-mounting/removal station located adjacent to the projection system; and
a droplet-removal nozzle disposed between the projection system and the substrate mounting/removal station, the droplet removal nozzle including:
the liquid removal device of claim 17.

31. A device manufacturing method comprising:
exposing a substrate by projecting a pattern image onto the substrate through an immersion liquid and the projection system of the immersion lithography apparatus of claim 27; and
developing the exposed substrate.
